(19) United States
(12) Patent Application Publication
(10) Pub. No.: US 2025/0377741 A1
(43) Pub. Date: Dec. 11, 2025

(54) CAPACITIVE PEN

(71) Applicant: Weiyu (Shenzhen) Technology Co., Ltd., Shenzhen (CN)

(72) Inventor: Xiangwen Jiang, Shenzhen (CN)

(21) Appl. No.: 18/912,632

(22) Filed: Oct. 11, 2024

(30) Foreign Application Priority Data
Jun. 5, 2024 (CN) 202421277178.6

(51) Int. Cl. G06F 3/0354; G06F 3/038; G10K 9/12; H02J 50/10

(52) U.S. Cl. CPC G06F 3/03545; G06F 3/0383; G10K 9/12; H02J 50/10

(57) ABSTRACT

The present application belongs to the technical field of electronic device accessories, and discloses a capacitive pen, which includes a pen barrel, a locator and a battery. The locator and the battery are both provided in the pen barrel, and the locator is electrically connected to the battery; the locator is configured to transmit wireless signals and/or receive wireless signals to locate the position of the capacitive pen. The present application can obtain the position of the capacitive pen through the locator to facilitate quick finding of the capacitive pen and prevent the loss of the capacitive pen.

### CROSS REFERENCES TO RELATED APPLICATION

The present application claims the benefit of Chinese Patent Application No. 202421277178.6 filed on June 5, 2024, the contents of which are incorporated herein by reference in their entirety.

### TECHNICAL FIELD

The present application relates to the technical field of electronic device accessories, and in particular, to a capacitive pen.

### BACKGROUND ART

With the emergence of a large number of capacitive screen devices such as smart capacitive screen touch-control phones, tablet PCs, and all-in-one desktop computers, the demand for refined operation of touch screens has increased. The emergence of capacitive pens is to perform input operations on phones and tablet PCs more quickly and accurately, and has become an indispensable part of modern mobile devices. Capacitive pen is a pen made of conductor material with conductive properties, which is used to touch and control the capacitive screen to complete man-machine dialogue operation. It is mainly used for writing, painting and other operations of touch screen devices. Users do not need to operate for a long time with their fingers, thus avoiding the fatigue caused by the long-term entertainment and work.

In order to realize the loss prevention of the capacitive pen main body, the electronic devices on the market generally reserve the accommodation space for the capacitive pen main body. Because the capacitive pen main body occupies a large space, it is necessary to make a trade-off in the electronic device to accommodate the capacitive pen main body, which often leads to the appearance of the electronic device is unattractive because of the accommodation space of the capacitive pen main body. In addition, there is also a capacitive pen main body of the magnetic suction type on the market, which connects the capacitive pen with the electronic device through magnetic suction to prevent loss.

In view of the above technical means, the principle of loss prevention is to connect and bundle the capacitive pen with the electronic device. Once the capacitive pen is separated from the electronic device main body, the capacitive pen still has the defect of being easily lost.

### SUMMARY OF THE INVENTION

The embodiment of the present application provides a capacitive pen, which can obtain the position of the capacitive pen through an electronic device to facilitate the quick finding of the capacitive pen and prevent the loss of the capacitive pen.

The capacitive pen provided by the present application adopts the following technical solutions:

a capacitive pen, including a pen barrel, a locator and a battery, wherein the locator and the battery are both provided in the pen barrel, and the locator is electrically connected to the battery; the locator is configured to transmit wireless signals and/or receive wireless signals to locate the position of the capacitive pen.

Further, the capacitive pen further includes a controller and a switch, wherein the controller is electrically connected to the locator, the locator is configured for Bluetooth connection with an electronic device, and the switch is electrically connected in a connection circuit between the battery and the controller.

Further, the capacitive pen further includes a buzzer, wherein the buzzer is electrically connected to the controller, and the buzzer is triggered by an application program of the electronic device to emit a sound for finding the capacitive pen.

Further, the pen barrel is provided with an accommodating chamber, and the locator, the controller, the battery and the buzzer are all provided in the accommodating chamber.

Further, the capacitive pen further includes a pen tip, wherein the pen tip is positioned at one end of the pen barrel, the pen tip being provided with a mounting portion, and the mounting portion is plugged into the pen barrel.

Further, the mounting portion is provided with a first magnet, and a second magnet is provided at one end of the pen barrel close to the mounting portion, and the first magnet and the second magnet are magnetically connected.

Further, one end of the pen tip away from the pen barrel is a touch-control portion, and the touch portion is in contact with a capacitive screen of the electronic device for input operation, and the touch portions of different pen tips are made of different materials to produce different capacitive responses to the capacitive screen.

Further, one end of the pen barrel away from the pen tip is provided with a pen cap, and a Type-c charging interface is provided in the pen cap, and the Type-c charging interface supplements power to the battery through an electric wire.

Further, the pen barrel is further provided with a magnet group and a wireless charging coil, the magnet group and the wireless charging coil are both provided on the pen barrel, and the magnet group is provided around the wireless charging coil, and the wireless charging coil cooperates with the magnet group to supplement power to the battery.

Further, the pen barrel is provided with a mounting frame, the mounting frame is positioned within the accommodating chamber, and the controller, the locator and the battery are all provided side by side along the length direction of the pen barrel and are fixedly connected to the mounting frame.

As can be seen from the above technical solutions, the embodiment of the present application has the following advantages:

A locator is added to the capacitive pen, and the locator transmits wireless signals and/or receives wireless signals to locate the position of the capacitive pen to realize the locating function of the capacitive pen, so as to obtain the position of the capacitive pen to facilitate the quick finding of the capacitive pen and prevent the loss of the capacitive pen.

### BRIEF DESCRIPTION OF THE DRAWINGS

FIG. 1 is an overall structural schematic diagram of a capacitive pen disclosed in an embodiment of the present application.

FIG. 2 is a structural schematic diagram of the capacitive pen highlighting the inside structure of a pen barrel disclosed in the embodiment of the present application; and

FIG. 3 is a structural schematic diagram of the capacitive pen highlighting the connection between a pen tip and a pen barrel disclosed in the embodiment of the present application;

FIG. 4 is another structural schematic diagram of the capacitive pen highlighting the inside structure of the pen barrel disclosed in the embodiment of the present application;

FIG. 5 shows another angle of the structural schematic diagram of the internal structure shown in FIG. 4.

### Description of Reference Numbers

1. pen barrel; 11. mounting frame; 12. second magnet; 2. controller; 3. locator; 4. battery; 5. pen tip; 51. mounting portion; 52. touch-control portion; 53. first magnet; 6. pen cap; 61. Type-c charging interface; 7. magnet group; 8. wireless charging coil; 9. switch; 10. buzzer.

### DETAILED DESCRIPTION OF THE INVENTION

The present application will be described in further detail below with reference to the accompanying drawings.

The embodiment of the present application provides a capacitive pen, which obtains the position of the capacitive pen through an electronic device to facilitate the quick finding of the capacitive pen and prevent the loss of the capacitive pen.

In order to enable those skilled in the art to better understand the solutions of the present invention, the technical solution in the embodiments of the present invention will be clearly and completely described below with reference to the accompanying drawings in the embodiments of the present invention, and it is obvious that the described embodiments are only some embodiments of the present invention, but not all embodiments. Based on the embodiments in the present invention, all other embodiments obtained by those skilled in the art without creative work should belong to the scope of protection of the present invention.

The terms "first", "second", "third", "fourth" and the like in the description and claims of the present invention and in the above-described drawings are used to distinguish similar objects, and are not necessarily used to describe a specific order or sequence. It is to be understood that the data so used are interchangeable under appropriate circumstances such that the embodiments described herein can be implemented in other orders than what is illustrated or described herein. Furthermore, the terms "comprise" and "include" and any variations thereof are intended to cover a non-exclusive inclusion, for example, a process, method, system, product, or device comprising a series of steps or units is not necessarily limited to those steps or units that are clearly listed, but may include other steps or units that are not clearly listed or inherent to such process, method, product, or device.

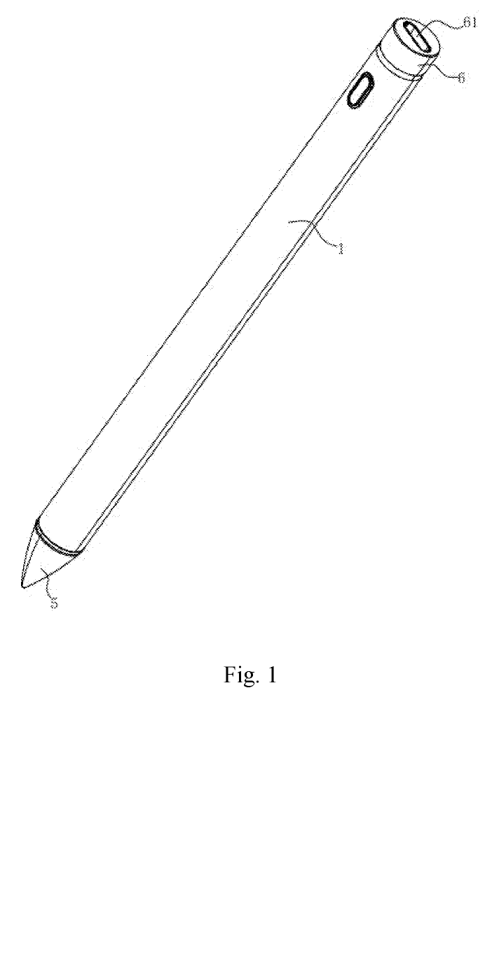

To facilitate understanding, the capacitive pen according to an embodiment of the present application is described below. Referring to FIG. 1, an embodiment of the capacitive pen according to an embodiment of the present application includes: a pen barrel 1, a controller 2, a locator 3 and a battery 4. The controller 2, the locator 3 and the battery 4 are all provided in the pen barrel 1. The controller 2 and the locator 3 are both electrically connected to the battery 4. The controller 2 is responsible for managing the power supply of the capacitive pen to ensure the normal use of the capacitive pen. The locator 3 is configured to transmit wireless signals and/or receive wireless signals to locate the position of the capacitive pen.

In the embodiment, both ends of the pen barrel 1 are respectively provided with a pen tip 5 and a pen cap 6. The pen tip 5 is configured to make contact with a capacitive screen of the electronic device for information input and is detachably connected to the pen barrel 1; the pen cap 6 is fixed to the pen barrel 1. Further, the pen barrel 1 is provided with a accommodating chamber, and the controller 2, the locator 3, and the battery 4 are all provided in the accommodating chamber. In some other embodiments, the other components such as the controller 2, the locator 3, and the battery 4 may be provided at any position of the pen barrel 1, the pen tip 5, or the pen cap 6. The pen barrel 1 is provided in a cylindrical shape. In other embodiments, the pen barrel 1 may be provided in any shape, which is not particularly limited herein.

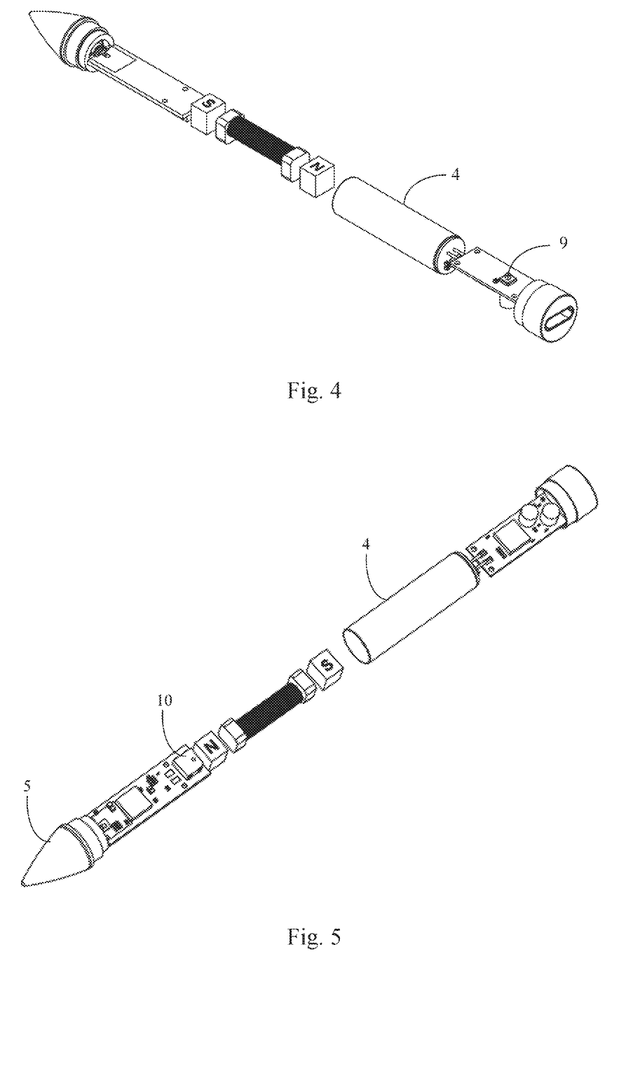

Referring to FIG. 1 to FIG. 5, the pen barrel 1 is provided with a mounting frame 11, and the mounting frame is positioned within the accommodating chamber. In the embodiment, the controller 2, the battery 4, and the locator 3 are all provided side by side along the length direction of the pen barrel 1 and are all fixedly connected to the mounting frame 11, thereby enhancing the mounting stability of the controller 2, the battery 4, and the locator 3.

The capacitive pen is further provided with a switch electrically connected in a connection circuit between the battery 4 and the controller 2, and the switch 9 is positioned on the pen barrel 1 and is configured to control the opening or closing of the capacitive pen.

The locator 3 is connected to the electronic device by Bluetooth, and the locating function of the capacitive pen is realized by adding the locator 3 in the capacitive pen and being paired and connected to the electronic device by using the Bluetooth technology, so as to obtain the position of the capacitive pen to facilitate quick finding of the capacitive pen and prevent the loss of the capacitive pen. In the present embodiment, the locator 3 is run based on the Find My application of the Apple device. Further, in order to remind the position of the capacitive pen, the capacitive pen is also provided with a buzzer electrically connected to the controller 2, and the buzzer is triggered by an application program of the electronic device to emit a sound for finding the capacitive pen. A part of the buzzer corresponding to the pen barrel 1 is provided with a sound hole.

When the capacitive pen has not been paired with an Apple device (such as an iPhone or iPad), or when the capacitive pen is removed from the application, the locator 3 in the capacitive pen in this state will send a Bluetooth broadcast waiting for pairing to detect and connect the capacitive pen; when the capacitive pen is paired, the user may click the "Play Sound" button in the Find My application of the electronic device to make the buzzer 10 sound, so as to remind the user of the position of the capacitive pen to facilitate finding of the capacitive pen.

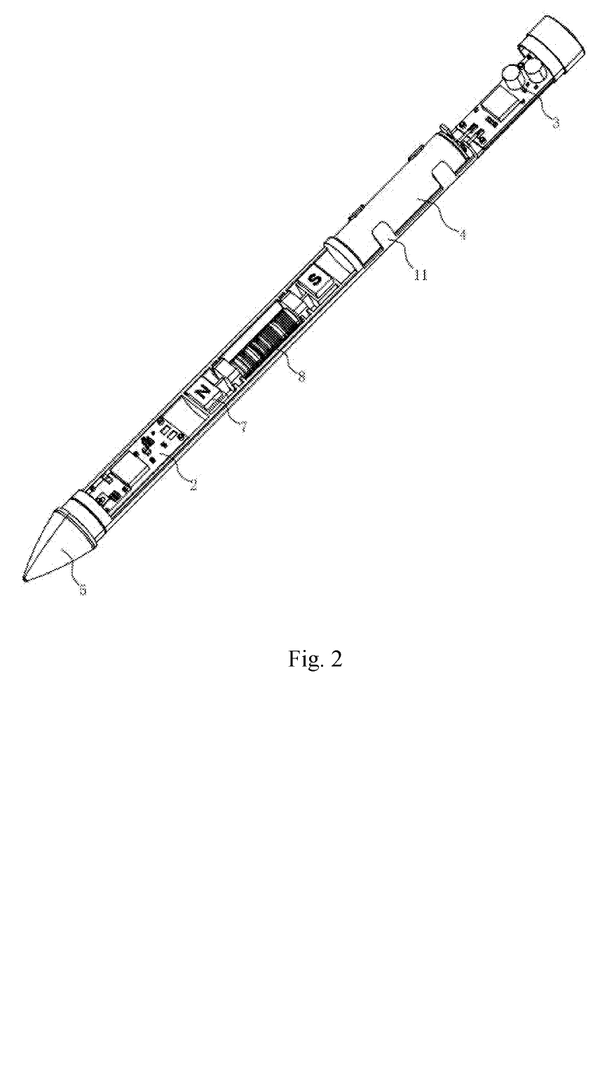

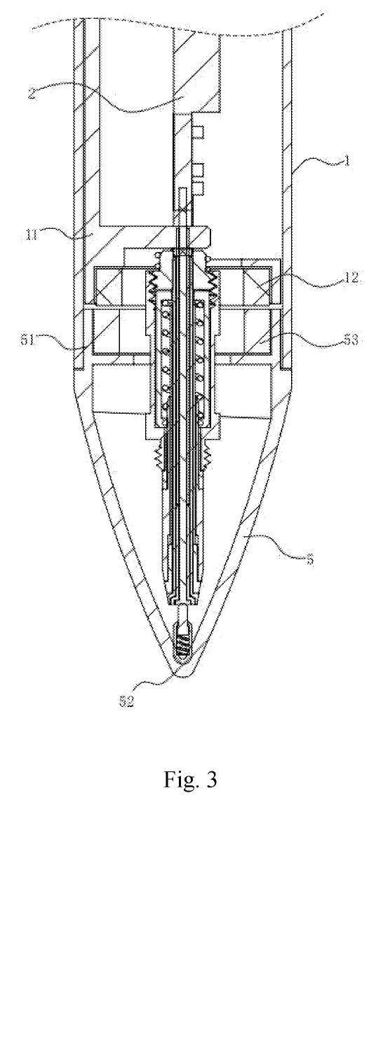

Referring to FIG. 2 and FIG. 3, the pen tip 5 is provided with a mounting portion 51 and a touch-control portion 52. One end of the pen tip 5 away from the pen barrel 1 is the touch-control portion 52, the mounting portion 51 is positioned in the accommodating chamber and is plugged into the pen barrel 1, and the touch-control portion is configured to make contact with a capacitive screen of the electronic device for input operation. The touch portions 52 of different pen tips 5 are made of different materials to produce different capacitive responses to the capacitive screen, thereby satisfying the needs of users in different scenarios.

In order to realize convenient and quick replacement of pen tips 5 of different specifications and experience different writing feelings, the mounting portion 51 is provided with a first magnet 53, and a second magnet 12 is provided at one end of the pen barrel 1 close to the mounting portion 51. The first magnet 53 and the second magnet 12 are magnetically connected. Specifically, both the mounting portion 51 and one end of the pen barrel 1 close to the mounting portion 51 are provided with flanges, and the flanges are provided on the inner wall of the mounting portion 51 and the accommodating chamber. The first magnet 53 and the second magnet 12 are fixedly mounted on the side walls of the corresponding flanges, respectively. The use of a magnetic suction type pen tip 5 doesn’t require a structural component for the fixation between the pen tip 5 and the pen barrel 1. Relative to the threaded connection, the magnetic suction structure of the first magnet 53 and the second magnet 12 is used to enhance the mounting stability between the pen tip 5 and the pen barrel 1 on the one hand; on the other hand, the pen tip 5 may be replaced conveniently and quickly, and can support the replacement of a plurality of different types of pen tips 5.

Referring to FIG. 2, a Type-c charging interface 61 is provided in the pen cap 6, and the Type-c charging interface 61 supplements power to the battery 4 through an electric wire. Further, the pen barrel 1 is further provided with a magnet group 7 and a wireless charging coil 8. The magnet group 7 and the wireless charging coil 8 are provided in the accommodating chamber, and the magnet group 7 is provided around the wireless charging coil 8, and the wireless charging coil cooperates with the magnet group 7 to supplement power to the battery 4. In the present embodiment, both the wireless charging coil and the magnet group 7 are fixedly mounted on the mounting frame 11. The magnet group 7 includes two magnets, and the two magnets are respectively positioned at both ends of the wireless charging coil. Compatible with Type-c cable charging and magnetic suction wireless charging expands the applicability of capacitive pens in usage scenarios.

As described above, the above embodiments are merely used to describe the technical solution of the present invention, and are not intended to limit the technical solution thereof. Although the present invention has been described in detail with reference to the aforementioned embodiments, those skilled in the art should understand that the technical solutions described in the aforementioned embodiments may be modified or some technical features may be equivalently replaced. However, these modifications or replacements do not deviate the essence of the corresponding technical solutions from the spirit and scope of the technical solutions of each embodiment of the present invention.

1. A capacitive pen, comprising a pen barrel (1), a locator (3) and a battery (4), wherein the locator (3) and the battery (4) are both provided in the pen barrel (1), and the locator (3) is electrically connected to the battery (4); the locator (3) is configured to transmit wireless signals and/or receive wireless signals to locate the position of the capacitive pen.

2. The capacitive pen according to claim 1, further comprising a controller (2) and a switch (9), wherein the controller (2) is electrically connected to the locator (3), the locator (3) is configured for Bluetooth connection with an electronic device, and the switch (9) is electrically connected in a connection circuit between the battery (4) and the controller (2).

3. The capacitive pen according to claim 2, further comprising a buzzer (10), wherein the buzzer (10) is electrically connected to the controller (2), and the buzzer (10) is triggered by an application program of the electronic device to emit a sound for finding the capacitive pen.

4. The capacitive pen according to claim 3, wherein the pen barrel (1) is provided with an accommodating chamber, and the locator (3), the controller (2), the battery (4) and the buzzer (10) are all provided in the accommodating chamber.

5. The capacitive pen according to claim 1, further comprising a pen tip (5), wherein the pen tip (5) is positioned at one end of the pen barrel (1), the pen tip (5) being provided with a mounting portion (51), and the mounting portion (51) is plugged into the pen barrel (1).

6. The capacitive pen according to claim 5, wherein the mounting portion (51) is provided with a first magnet (53), and a second magnet (12) is provided at one end of the pen barrel (1) close to the mounting portion (51), and the first magnet (53) and the second magnet (12) are magnetically connected.

7. The capacitive pen according to claim 6, wherein one end of the pen tip (5) away from the pen barrel (1) is a touch-control portion (52), and the touch portion (52) is in contact with a capacitive screen of the electronic device for input operation, and the touch portions (52) of different pen tips (5) are made of different materials to produce different capacitive responses to the capacitive screen.

8. The capacitive pen according to claim 5, wherein one end of the pen barrel (1) away from the pen tip (5) is provided with a pen cap (6), and a Type-c charging interface (61) is provided in the pen cap (6), and the Type-c charging interface (61) supplements power to the battery (4) through an electric wire.

9. The capacitive pen according to claim 8, wherein the pen barrel (1) is further provided with a magnet group (7) and a wireless charging coil (8), the magnet group (7) and the wireless charging coil (8) are both provided on the pen barrel (1), and the magnet group (7) is provided around the wireless charging coil (8), and the wireless charging coil (8) cooperates with the magnet group (7) to supplement power to the battery (4).

10. The capacitive pen according to claim 4, wherein the pen barrel (1) is provided with a mounting frame (11), the mounting frame (11) is positioned within the accommodating chamber, and the controller (2), the locator (3) and the battery (4) are all provided side by side along the length direction of the pen barrel (1) and are fixedly connected to the mounting frame (11).
